(19) United States
(12) Patent Application Publication
(10) Pub. No.: US 2024/0424560 A1
(43) Pub. Date: Dec. 26, 2024

(54) VARIABLE LINE SPACING PRINT METHOD FOR UNSUPPORTED FEATURES IN THREE-DIMENSIONAL OBJECTS

(71) Applicant: Additive Technologies, LLC d/b/a ADDiTEC, Palm City, FL (US)

(72) Inventors: PriyaankaDevi GUGGILAPU, Durham, NC (US); Chu-Heng LIU, Penfield, NY (US); Dinesh Krishna Kumar JAYABAL, Rochester, NY (US)

(73) Assignee: Additive Technologies, LLC d/b/a ADDiTEC, Palm City, FL (US)

(21) Appl. No.: 18/338,998

(22) Filed: Jun. 21, 2023

(51) Int. Cl. B22F 10/22; B22F 10/40; B33Y 10/00

(52) U.S. Cl. CPC B22F 10/22; B22F 10/40; B33Y 10/00; B22F 2301/052

(57) ABSTRACT

A method of forming a three-dimensional part is disclosed, including ejecting one or more drops of a print material at a first frequency to form a portion of a three-dimensional part. The method also includes ejecting one or more drops of the print material at a first line spacing, creating an unsupported overhang onto the three-dimensional printed part where the unsupported overhang is oriented at an angle of from 0 degrees to about 45 degrees relative to a print bed, and ejecting one or more drops of the print material at a second line spacing when creating at least a portion of the unsupported overhang. The method of forming a three-dimensional part further includes where drops are ejected at a first drop spacing when ejected at the first line spacing or at the second line spacing, and no portion of the unsupported overhang contacts the print bed.

### TECHNICAL FIELD

The present teachings relate generally to printing methods for three-dimensional objects and, more particularly, to variable line spacing to provide unsupported features in printing three-dimensional objects.

### BACKGROUND

A drop-on-demand (DOD) or three-dimensional (3D) printer builds (e.g., prints) a 3D object from a computer-aided design (CAD) model, usually by successively depositing material layer upon layer. A drop-on-demand (DOD) printer, for example, one that prints a metal or metal alloy, ejects a small drop of liquid aluminum alloy when a firing pulse is applied. Using this technology or others using various printing materials, a 3D part can be created by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer which bond together to form a 3D metallic object. Magnetohydrodynamic refers to the study of the magnetic properties and the behavior of electrically conducting fluids.

Furthermore, 3D printing technology is well known for enabling the manufacture of complex 3D designs which otherwise could not be made using traditional methods such as machining, casting, or injection molding. This ability is made possible through a common trait that all the 3D printing processes share, which is to divide a given geometry along the printing direction into multiple two-dimensional (2D) layers and print one layer at a time. In this approach, complex features, such as re-entrant geometries, hollow features, fine features which the traditional tools cannot machine owing to space constraints or reachability, and the like, are divided among multiple layers and fairly simple 2D layers are printed one above the other until the entire object is completed in this fashion. Despite this straightforward approach, each 3D printing process by virtue of its working principle or construction has its own challenges to tackle. One such common challenge manifests in the form of overhangs. An overhang is an unsupported feature of a 3D printed part that is unsupported by an underlying support structure. A layer-by-layer printing approach can produce one or more undersides of a slope in a part, where each subsequent layer must protrude slightly beyond a preceding layer. As the molten printed material is still in its flowable liquid state prior to solidification, gravity and other factors, such as the angle and slope of the overhang, can result in drooping or sagging, curling, or the prohibition of printing a desired shape altogether.

Thus, a method of and apparatus for printing overhangs and other unsupported features or structures in a drop-on-demand or 3D printer is needed to produce a wider variety of features in 3D printed parts and avoid issues with unsupported structural features.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of forming a three-dimensional part is disclosed. The method of forming a three-dimensional part includes ejecting one or more drops of a print material at a first frequency to form a portion of a three-dimensional part. The method also includes ejecting one or more drops of the print material at a first line spacing, creating an unsupported overhang onto the three-dimensional printed part where the unsupported overhang is oriented at an angle of from 0 degrees to about 45 degrees relative to a print bed, and ejecting one or more drops of the print material at a second line spacing when creating at least a portion of the unsupported overhang. The method of forming a three-dimensional part further includes where drops are ejected at a first drop spacing when ejected at the first line spacing or at the second line spacing, and no portion of the unsupported overhang contacts the print bed. Implementations of the method of forming a three-dimensional part may include ejecting one or more drops of the print material at a second frequency. The method may include where the first frequency is from about 200 Hz to about 400 Hz, and the second frequency is from about 50 Hz to about 300 Hz. The second frequency can be 100 Hz. In implementations, ejecting one or more drops of the print material at a second frequency is done at the same time as ejecting one or more drops of the print material at a second line spacing. The unsupported overhang can be an extended overhang. The unsupported overhang can be a central overhang. The first line spacing is greater than the second line spacing, or in other examples, the second line spacing is greater than the first line spacing. Drops can be ejected at a second drop spacing, and in examples, the first drop spacing is greater than the second drop spacing. The second drop spacing can alternatively be greater than the first drop spacing. The method of forming a three-dimensional part may include ejecting one or more drops of the print material at a second line spacing when creating at least a portion of the unsupported overhang, and ejecting one or more drops of the print material at a second drop spacing when creating at least a portion of the unsupported overhang. The first line spacing can either be greater than the second line spacing or the second line spacing can be greater than the first line spacing. The unsupported overhang can be an extended overhang, where a lateral dimension of the unsupported overhang is up to 3 mm. The unsupported overhang can be a central overhang where a lateral dimension of the unsupported overhang is up to 6 mm.

Another method of forming a three-dimensional part is disclosed. The method of forming a three-dimensional part includes ejecting one or more drops of a print material at a first frequency to form a portion of a three-dimensional part, ejecting one or more drops of the print material at a first line spacing, creating an unsupported overhang onto the three-dimensional printed part where the unsupported overhang is oriented at an angle of from 0 degrees to about 45 degrees relative to a print bed, and where drops are ejected at a first drop spacing when ejected at the first line spacing, and no portion of the unsupported overhang contacts the print bed or substrate.

Another method of forming a three-dimensional part is disclosed, including ejecting one or more drops of a print material to form a portion of a three-dimensional part, ejecting one or more drops of the print material at a first line spacing while forming the three-dimensional part. The method of forming a three-dimensional part also includes creating an unsupported overhang onto the three-dimensional printed part, where the unsupported overhang is oriented at an angle of from 0 degrees to about 45 degrees relative to a print bed and no portion of the unsupported overhang contacts the print bed. The method of forming a three-dimensional part also includes decreasing the first line spacing when creating at least a portion of the unsupported overhang. Implementations of the method of forming a three-dimensional part may include where the print material includes a metal, a metallic alloy, or a combination thereof.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid metal ejector jet of a 3D printer (e.g., a MHD printer and/or multi-jet printer), in accordance with the present disclosure.

FIG. 2 depicts a perspective view of a geometry of a three-dimensional printed part, in accordance with the present disclosure.

FIG. 3 depicts a perspective view of the three-dimensional printed part of FIG. 2, including support structures below the overhangs, in accordance with the present disclosure.

FIG. 4 depicts a schematic of a bridging layer formed onto support pillars to form a support for a 3D printed object, in accordance with the present disclosure.

FIG. 5 depicts a top plan view of a drop-based version of the part shown in FIG. 4, in accordance with the present disclosure.

FIG. 6 depicts a plot of stepout or overhang distance in millimeters as a function of line spacing in millimeters, in accordance with the present disclosure.

FIGS. 7A-7C are photographs showing several experimental 3D printed parts having varying sized external overhangs, in accordance with the present disclosure.

FIG. 8 depicts a top plan view of a drop-based version of the part having an unsupported stepout or overhang, in accordance with the present disclosure.

FIG. 9 depicts a schematic of a part having an unsupported stepout including a central overhang, in accordance with the present disclosure.

FIG. 10 depicts a schematic of a bridging layer formed onto support pillars to form a support for a 3D printed object having a central overhang, in accordance with the present disclosure.

FIG. 11 depicts a top plan view of a drop-based version of the part having an unsupported stepout including a central overhang, in accordance with the present disclosure.

FIG. 12 is a flowchart illustrating a method for forming a three-dimensional part, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

Print path can be defined as a path, or course, that a drop-on-demand printer follows according to its executed programmed instructions for completion of an object build. Line spacing can be defined as a distance interval between a printed line and a neighboring or adjacent printed line as a drop-on-demand printer follows programmed instructions for completion of an object build. Drop spacing can be defined as an interval between drops ejected from a drop-on-demand printing system. The interval between or drop spacing can be expressed in dimensions of time, for example, milliseconds, or distance, such as millimeters.

In a liquid drop-on-demand (DOD) jetting printing system, being able to produce unsupported overhangs is critical to expanding the range of designs that can be printed, in particular for internal cavities where a support pillar cannot be accessed to be removed after a three-dimensional (3D) part is completed. The present disclosure provides a system and method to create 0 degree (horizontal) overhangs up to 3 mm wide, which can also allow for providing internal channels or overhangs up to 6 mm wide utilizing a DOD 3D printing system. During creation of an overhang, lines of print material drops are deposited such that they are parallel to the overhang edge, so that each new line makes the overhang larger in a vertical direction. The line spacing, or center-to-center spacing from one line to the next for a particular size of overhang was experimentally-determined and while not perfectly linear, can be approximated by a line spacing=0.2444-0.017×(overhang distance), such that the lines are deposited closer together as the overhang size increases. If the lines are deposited too close together, all or part of the overhang can begin to climb in a positive vertical direction, and if lines are deposited too far apart, all or part of the overhang can droop. In examples, the jetting can be done at a frequency of 100 Hz, which is important due to the proper line or drop spacings being dependent upon thermal effects that change with extra cooling in the time between a deposition of print material drops. Since the designed length of the overhang will not likely be exactly the sum of an ideal line spacing, a formula is further provided herein for increasing the spacing of drops within the last line of the overhang to proportionally reduce the spatial density of material being deposited. In an optional example, if a last line in an overhang is only half as far away from the previous line as it was intended to be, the printing system can double an internal drop spacing to provide the correct amount of material in the finished part.

For the purposes of this disclosure, an overhang can be defined as an unsupported feature of a 3D printed part that is not held up or supported by an underlying support structure or other printed element. A layer-by-layer printing approach involving a liquid or molten print material can produce one or more undersides of a slope in a part, where each subsequent layer must protrude slightly beyond a preceding layer. As the molten printed material is still in its flowable liquid state prior to solidification, gravity and other factors, such as the angle and slope of the overhang, can result in drooping or sagging, curling, or the prohibition of printing a desired shape altogether. An extended overhang refers to an overhang extending in an outward facing or lateral direction relative to a previously formed portion of a three-dimensional part with only one contiguous area of contact between an initial portion of a three-dimensional part and the overhang. A central overhang refers to an overhang extending in an inward facing or lateral direction relative to a previously formed portion of a three-dimensional part with more than one, i.e. at least two, contiguous area of contact between an initial portion of a three-dimensional part and the central overhang. By way of example, a central overhang can also be referred to as a bridge or bridging layer within an entire structure of a three-dimensional part. For the purposes of this disclosure, the term “stepout” can be used interchangeably with overhang, as the ejected drops forming the unsupported overhang structure can be considered to “step out” at a 0 degree angle from a horizontal plane associated with a three-dimensional part or object in progress of being printed or created.

Examples of the present disclosure provide a printing approach that enables the printing of complex features such as re-entrant geometries, hollow features, overhangs, and fine features which traditional tools cannot machine due to space constraints or reachability and the like. These features may be printed using methods and systems of the present disclosure by printing structures and features which are divided among multiple layers and wherein fairly simple 2D layers can be printed one above the other until the entire object is completed.

Certain liquid printing processes can provide three-dimensional parts having extreme overhangs as described herein are only possible by bridging over support structures. Currently, support structure layers are made of finely spaced extended, solid supports constructed of a print material including aluminum or another applicable print material. Once the part has completed printing, these support structures must be removed, which can often leave a rough overhanging side due to molten metal or molten print material sinking between the fine gaps of the support structures prior to solidification and some remnant support structures can still be left attached to the part after support removal. This involves one or more secondary operations post-printing to provide a better surface finish. The printing of unsupported overhangs can provide printing processes having improved efficiency, reduced post-processing, and the like.

The present disclosure provides experimentally determined method for providing printed parts with an unsupported overhang of up to 3 mm. Moving or extending an overhang beyond this lateral distance produces a situation where the thermal properties of the part were such that the overhang would start to curl into a positive vertical direction. The examples provided herein provide greater design freedom for up to 3 mm horizontal overhangs without the need for post-processing to remove supports, and also provide 6 mm internal or central overhangs, which would be impossible otherwise since internal supports cannot be machined away.

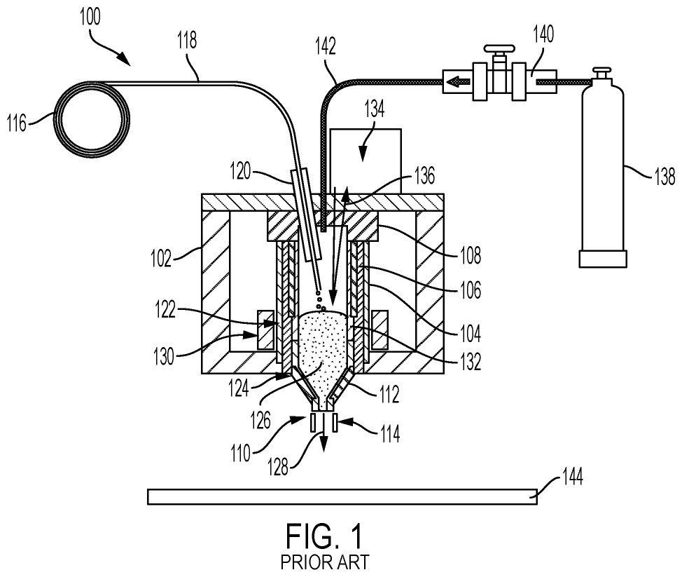

FIG. 1 depicts a schematic cross-sectional view of a single liquid metal ejector jet of a 3D printer (e.g., a MHD printer and/or multi-jet printer), in accordance with the present disclosure. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity or an inner cavity). A printing material 126 may be introduced into the inner volume 132 of the ejector 104. The printing material 126 may be or include a metal, a polymer, or the like. It should be noted that alternate jetting technology aside from MHD as described herein may be necessary depending on the nature and properties of the print material used in examples of the present disclosure. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. This electrical current can be provided as a pulse, which is delivered at a specific frequency, wherein the frequency determines a rate at which a pulse is delivered to the coils 106, and therefore how often a drop may be ejected from the ejector 104. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate 144, that is positioned proximate to (e.g., below) the nozzle 110. The ejected drops 128 may land on the substrate 144 and solidify to produce a 3D object. The 3D printer 100 may also include a substrate control motor that is configured to move the substrate 144 while the drops 128 are being jetted through the nozzle 110, or during pauses between when the drops 128 are being jetted through the nozzle 110, to cause the 3D object to have the desired shape and size. The substrate control motor may be configured to move the substrate 144 in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate 144 may be moved under a stationary nozzle 110, or the nozzle 110 may be moved above a stationary substrate 144. In yet another example, there may be relative rotation between the nozzle 110 and the substrate 144 around one or two additional axes, such that there is four or five axis position control. In certain examples, both the nozzle 110 and the substrate 144 may move. For example, the substrate 144 may move in X and Y directions, while the nozzle 110 moves up and/or down in a Y direction. For the purposes of this disclosure, a print bed may also refer to the substrate.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate 144 to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate 144, additional system elements, or a combination thereof may be positioned at least partially within the enclosure 102. In another example, the ejector 104, the heating elements 112, the power source, the coils, the substrate 144, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design examples.

Printing systems as described herein or printing systems having other print material feeds and/or ejection systems may alternatively include other printing materials such as plastics or other ductile materials that are non-metals. The print material can include a metal, a metallic alloy, or a combination thereof. A non-limiting example of a printing material can include aluminum. Exemplary examples of printing systems of the present disclosure can include an ejector for jetting a print material, including a structure defining an inner cavity, and a nozzle orifice in connection with the inner cavity and configured to eject one or more droplets of liquid print material, wherein the ejector is configured to form an overhang for a three-dimensional printed part.

The construction of the previously known support structures require the building of a front wall, a rear wall, and foundational walls having pillars formed on top of them that extend between the front wall and rear wall. The walls are typically formed with several drops adjacent to one another in the X and Y directions to provide an adequate base for the weight bearing to be endured by the structure. Additional drops are ejected onto the bases of the walls to build the walls to a predetermined height in a known manner. This known manner requires the building of the walls to be conducted with multiple passes around the perimeter of the support structure with the drops forming the bases of the wall being ejected at spaced intervals. The interval between drops in a pass is sufficient to distance the drops from one another so the drops in the same pass do not land on each other. Each subsequent pass ejects melted metal drops into spaces between previously ejected drops. The final few passes eject drops onto previously ejected drops to complete the base for a foundational wall. This procedure continues for building each layer of the foundational walls. The melted metal drops that form the foundational walls are ejected at a frequency of about 100 Hz with a drop spacing of about 0.28 mm. This selection frequency and drop spacing ensures that the drops are able to freeze and that the thermal load of the landed melted metal drops does not adversely impact the formation of the bases of the walls or the building of the solid metal walls. It should be noted that the balance of frequency and drop spacing can be interdependent upon one another in the context of cooling or solidification rates of a given class of drop or type of drop, with respect to the structural use or purpose of said drop. Therefore, various frequencies can be used in concert with various drop spacings to allow for a desired cooling or solidification rate of a drop. In examples, if a different metal alloy or print material, such as one that is polymer-based, the selection of ejection frequency and drop spacing may shift to a different range to provide a particular solidification rate for this different metal alloy or print material.

In this same known method, pillars are built on top of the front wall, the back wall, and the foundational walls. That is, multiple passes of the ejector head are used to form the bases for the pillars on the front wall, the back wall, and the foundational walls at a predetermined interval from one another and then subsequent passes eject one or more drops in multiple passes onto the solidified drops previously ejected for each pillar to extend each pillar above the wall.

In previously known printers, the pillars on the same wall are joined to one another with a line of metal drops. The line of metal drops is formed by ejecting a melted metal drop for each pillar that slightly overhangs the pillar so when it freezes it extends the top of the pillar in the direction of the next pillar. Subsequent passes eject a melted metal drop that slightly overhangs the previously ejected metal drop to extend the pillar further toward the next pillar. The passes continue until the pillars are joined to one another at their tops to form a continuous metal line over the pillars for each wall. The top layer of the support structure is formed by ejecting melted metal drops that slightly overhang the metal line connecting the pillar tops in a direction that extends one continuous metal line covering the pillars on one wall toward a continuous metal line covering the pillars on a next wall. Multiple passes are required to extend one continuous metal line toward another continuous metal line by one drop width at a time. This process is repeated until two continuous metal lines covering two separate groups of pillars on different walls have a layer that extends between them. In this manner, all of the continuous metal lines over the pillars on each wall are joined to one another to form the upper surface of the supporting structure. This previously known process for operating a 3D metal object printer to form a supporting structure is time consuming but is necessary to avoid adverse thermal impacts of melted metal drops landing too close to one another.

In still other known methods, printers such as those shown in FIG. 1 include a controller that is configured to operate the ejector head to construct pillars closer to one another on the foundational walls and to form the continuous metal lines connecting the pillars in a single pass. In such object builds requiring support structures, a front wall, a back wall, and one or more foundational walls are built in the known manner discussed above; however, the distance between adjacent pillars can be varied. In one embodiment, the distance is 0.85 mm. The pillars can be formed on a front wall, a back wall, or a foundational wall. One the walls and pillars are formed, the ejector head passes over each line of pillar tops that extends from the front wall to the back wall while ejecting melted metal drops in a single pass to form continuous metal lines over the lines of pillars. Thus, while manipulation of frequency and line spacing has been modified to create support structures, this deterministic use of a pre-calculated line or drop spacing as described in the present teachings has not been used within object builds to produce unsupported overhangs.

In previously known methods of printing, the formation of the support structures in 3D metal objects can be done with a metal drop ejecting 3D object printer as described herein. The maximum bridge distance achievable by previously known methods demonstrate the printing of unsupported overhangs, or those without any additional supporting structures was 7*0.25 mm=1.75 mm, which designates support pillars separated by 7 intervals each of 0.25 mm, which corresponds to printing 0.875 mm in a single, one way lateral direction without any supports, as determined by 1.75/2=0.875 mm. The present teachings provide method of determining and ejecting drops at one or more line spacings or spatial distances between adjacent lines to create an unsupported stepout, or overhang, for various stepout lengths to print at 0° angle from the horizontal. In these structures, where an unsupported overhang or stepout is formed, no support structure is present or required below the overhang. The present disclosure provides for a method of printing and a printing system configured to create objects or parts having an overhang distance of up to 3 mm, or from 0 mm to about 3 mm with a line spacing of about 0.2 mm, where To avoid droop, less material can be printed in a penultimate row, and step outs can be printed in alternating directions. Appropriate line spacings, in some examples can be derived from the equation y=−0.017x+0.2444, where x ranges from 0-3 mm, resulting in line spacings of from about 0.244 to about 0.1934 mm. It should be noted that similar calculations can be used with different system operating parameters or print materials, in still other examples.

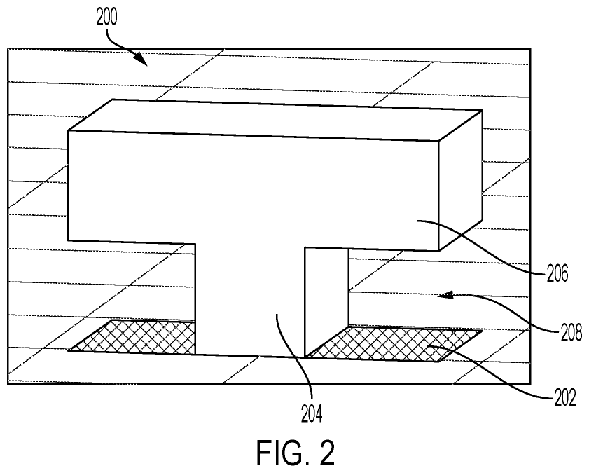

FIG. 2 depicts a perspective view of a geometry of a three-dimensional printed part, in accordance with the present disclosure. The 3D part or object is a “T” shaped part 200, which when printed using previously known methods, requires support structures below the stems of the T. Some of the more extreme forms of the overhanging features in 3D printed parts are overhangs that are parallel to the print bed of substrate 202. For example, a 3D object of the letter ‘T’ shaped part 200 can be printed by a 3D printing process by printing multiple layers. In the process point where there is an abrupt step out 206 at a 90 degree angle relative to the underlying stem 204 to begin forming the horizontal component of the letter, the undersides, or overhangs 208 not supported by a layer within the stem 204, are, in this example, parallel to the print bed or substrate 202. It can also be considered at a 0 degree angle relative to a horizontal plane where the overhang begins to step out. Methods and systems of the present disclosure include a printing approach which can produce one or more undersides of a slope in a part, where each subsequent layer must protrude slightly beyond a preceding layer without resulting in drooping or sagging, curling, or the prohibition of printing a desired shape according to a design. Methods and systems of the present disclosure provide for printing at an overhang angle from about 0 degrees to about 45 degrees, or from 0 degrees to about 10 degrees.

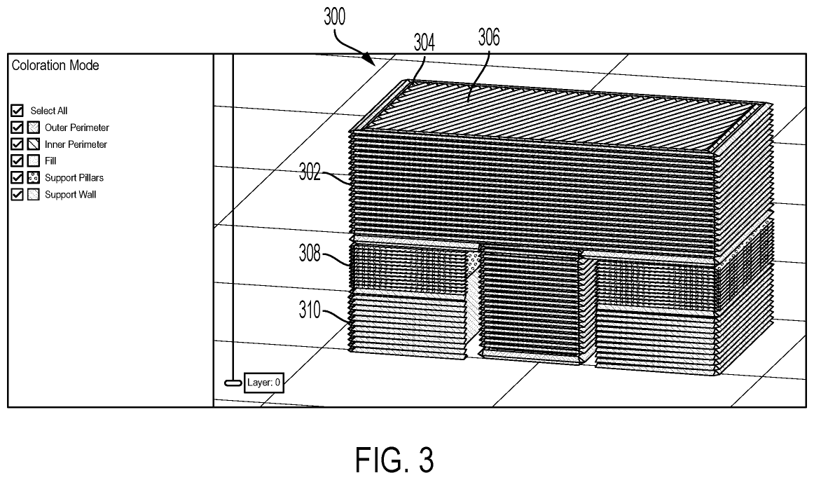

FIG. 3 depicts a perspective view of the three-dimensional printed part of FIG. 2, including support structures below the overhangs, in accordance with the present disclosure. This particular part build configuration requires support structures below the stems of T as shown in FIG. 3. The three-dimensional printed part 300 includes a stepout or overhang 302 portion of the part 300, where a support wall 310 and several support pillars 308 are required to provide support to the overhang 302. In this instance, the overhang 302 is an extended overhang. Also shown in the part 300 are an inner perimeter 304 of the top portion of the part and a fill portion 306. A fill portion is a portion of a part 300 that is filled in with print material and provides an internal structure of the part 300.

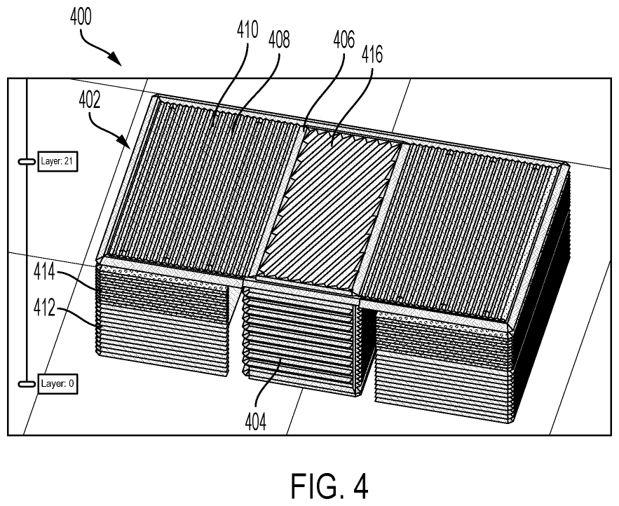

FIG. 4 depicts a schematic of a bridging layer formed onto support pillars to form a support for a 3D printed object, in accordance with the present disclosure. A more detailed view of the structure found in a part similar to that shown in FIG. 3. This bridging layer has supported step out portions 410 directly on top of support pillars 414 and unsupported step out portions 408 between them. The three-dimensional printed part 400 includes a stepout or overhang 402 portion of the part 400, where a support wall 412 and several support pillars 414 are required to provide support to the overhang 402. In this instance, the overhang 402 is also an extended overhang. Also shown in the part 400 are an inner perimeter 304 of the top portion of inner perimeter 406 of a stem 404 which is a vertical portion of the part 400, and a fill portion 416 of the stem 404. Also shown in this schematic are unsupported portions 408 of overhang 402, an outer perimeter 410 of the overhang 402.

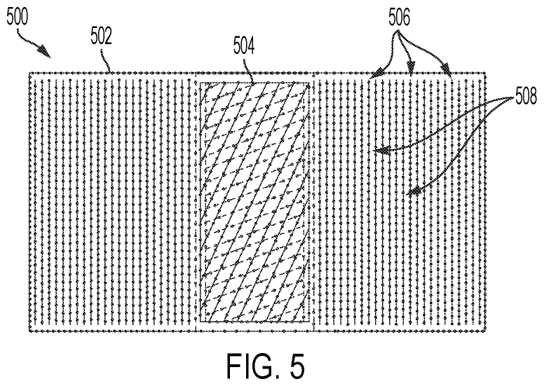

FIG. 5 depicts a top plan view of a drop-based version of the part shown in FIG. 4, in accordance with the present disclosure. As shown in a top view of the part 500, within the extended overhang 502, there are drop-based print paths shown with a plurality of lines representing one or more paths and a plurality of circles representing the drops of printing material forming the layer of the part 500. The lines and circles show a difference between a supported step out/overhang portion 506 and an unsupported stepout/overhang portion 508 having a larger spatial distance between drops. In this example, there are six unsupported step outs 508 interspersed between the supported step outs 506, each line spacing being 0.25 mm apart. Also shown is a drop pattern for the fill 504 portion of the part 500. It should be noted that in examples of nominal printing, line spacing is typically constant, for example, 0.25 mm.

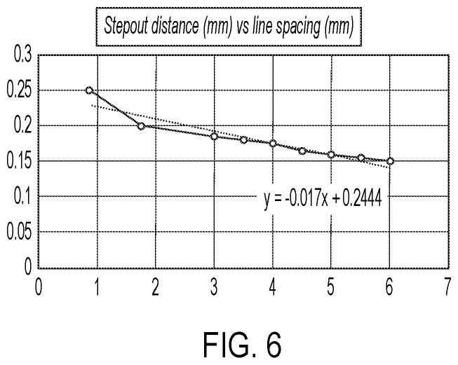

FIG. 6 depicts a plot of stepout or overhang distance in millimeters as a function of line spacing in millimeters, in accordance with the present disclosure. To print step outs or overhangs greater than 0.875 mm, the line spacing between the unsupported step outs is decreased gradually based on the length of the overhang, or stepout. As shown in FIG. 6, the length of overhang or stepout, or the width of a side of the “T,” as shown in FIG. 2, is plotted as a function of the line spacing value.

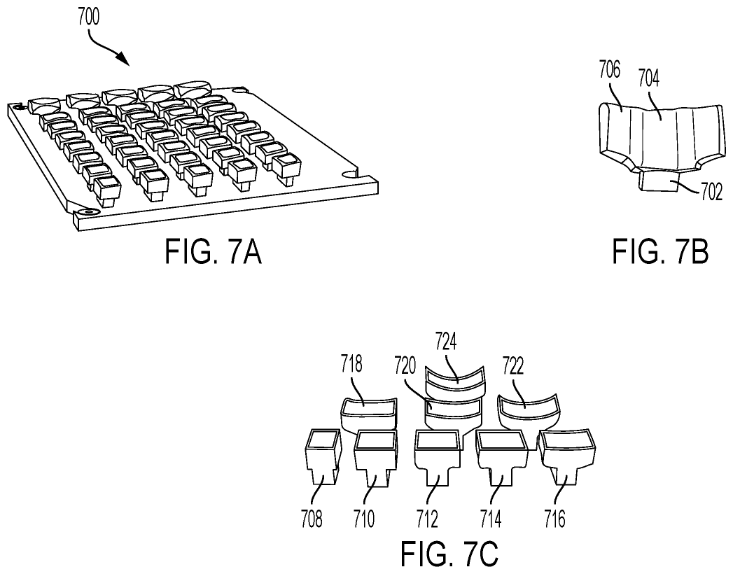

This was experimentally verified and supported by placing “T” of different step outs and varying the line spacing as shown in FIGS. 7A-7C. FIGS. 7A-7C are photographs showing several experimental 3D printed parts having varying sized external overhangs, in accordance with the present disclosure. During the printing of the parts 700 shown in FIGS. 7A-7C,

When printing the bridging layers there are two additional parameters followed by the printer and associated controllers, motion controls, and software. One is printing, or ejecting drops of printing materials at 100 Hz, as compared to a standard jetting frequency of 300 Hz. While standard jetting operations can include a first frequency from about 200 Hz to about 400 Hz, when printing such bridging or unsupported stepout lines for overhangs, as described herein, a second frequency for ejecting drops to form an unsupported stepout or portion of an overhang can be from about 50 Hz to about 300 Hz. In certain examples, the drop spacing of the last unsupported stepout can be altered to account for the spacing when not exactly at the desired spacing, according to how the part is designed. In previous printers and methods, jetting drops of print material has been practiced within a bridging layer in a stepout portion of an overhang is completed at a frequency of 300 Hz, but in the present teachings, the overhang can be printed at 100 Hz, which is considered to eliminate the drooping of the corners as part creation begins to start or step out in a horizontal plane from an existing portion of a printed part or object. While certain frequencies are stated herein, other conditions may be required for certain geometries or with the use of other printing materials. In some examples, printing at 100 Hz provides improved jetting stability which allows for the retention of additional heat during drop ejection and part creation which results in less droop. While one example print material includes aluminum, the method and systems described herein can be applied to drop-on-demand printing with plastics or other printing materials. Examples herein provide improved printing while preventing fall off, which occurs when print material cannot solidify fast enough, and so when printed at higher frequency, new drops bring in heat of additional print material. Lower frequency printing can reduce the resulting heat and allow for faster solidification, leading to less fall off during part build.

Since unsupported step outs become cold as they are printed further from the part, the drops sticks to a previous unsupported stepout to form an overhang instead of a flat surface. In examples, a maximum unsupported stepout or overhang that can be printed without lifting or moving into a positive vertical direction is approximately 3 mm experimentally. For example, FIG. 7B shows a the “T” shaped part 704 having a stem portion 702, having a 6 mm stepout or overhand 706 on both sides when printed at 300 Hz. In this example, the extended overhang 706 shows an upwardly increasing slope as the overhang 706 extends a further distance from the stem portion 702. FIG. 7C includes additional “T” shaped parts having overhang widths of 0.875 mm 708, 1.75 mm 710, 3 mm 712, 3.5 mm 714, 4 mm 716, 4.5 mm 718, 5 mm 720, 5.5 mm 722 and 6 mm 724 are printed with their respective line spacing values derived from the experiments as shown in regard to FIG. 6. Overhangs having a stepout distance of more than 3 mm form an upward angle and cannot be printed flat with approach as described herein. In other examples, however, this method can be used to print internal channels or central overhangs of 6 mm, or 3 mm from two opposing directions.

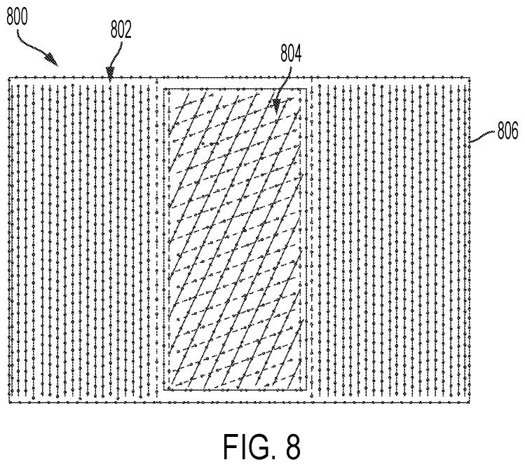

FIG. 8 depicts a top plan view of a drop-based version of a part having an unsupported overhang including an extended overhang, in accordance with the present disclosure. As shown in a top view of the part 800, within the extended overhang 802, there are drop-based print paths shown with a plurality of lines representing one or more paths and a plurality of circles representing the drops deposited along each path of printing material forming the layer of the part 800. The lines and circles show a consistent line spacing and drop spacing for most of the portion of the extended overhang 802. In examples, where the very last unsupported step out is near to the edge of the part, which occurs when the stepout or overhang to be printed is not a multiple of line spacing value, the drop spacing of the last unsupported stepout path on the overhang is changed to compensate for any potential overbuild. The new drop spacing value is greater than the nominal unsupported stepout value of 0.28 mm by a percentage difference between the actual line spacing and the desired line spacing. For example, the drop spacing for a last unsupported stepout can be calculated as 0.28+0.28*(l_{sd}−lₛₐ)/l_{sd}, where l_{sd} is a desired line spacing and La is actual line spacing. This is the same case when printing internal channels, the bridging starts from both of the opposing sides and the drop spacing of the unsupported stepout in the middle of the bridging layer can similarly be adjusted. This particular drop spacing calculation can also apply to the last unsupported stepout when printing an overhang of 0 deg from the horizontal with supports. Also shown is a drop pattern for the fill 804 portion of the part 800.

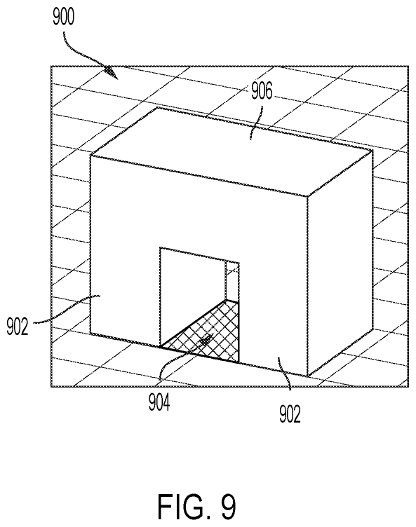

FIG. 9 depicts a schematic of a part having an unsupported stepout including a central overhang, in accordance with the present disclosure. In the three-dimensional part 900 shown in FIG. 9 two stem portions 902 are included in the structure, with a central overhang 906. The unsupported central overhang 906 has an absence 904 of any support walls pillars or other structures. When printing internal channels, or central overhangs as shown in FIGS. 9-11, the unsupported step outs originate from either sides of the bridge and meet in the middle of the central overhang. The two central unsupported overhang portion might not be at the desired spacing from one another, which can occur when the stepout to be printed is not a multiple of the line spacing value. In such examples, the drop spacing of the central unsupported step outs are changed to compensate for the overbuild. The new drop spacing value is greater or less than the nominal unsupported stepout value of 0.28 mm and is calculated as follows. If 0<=lsₐ<ls_{d}, the new drop spacing=0.28+0.28*(ls_{d}−lsₐ)/ls_{d}. Otherwise, if ls_{d}<lsₐ<2*ls_{d}, the new drop spacing=0.14+0.14*(2*ls_{d}−lsₐ)/ls_{d}. In other examples, no change is made, as ls_{d} is a multiple of ls_{d}, where ls_{d} is desired line spacing and lsₐ is actual line spacing.

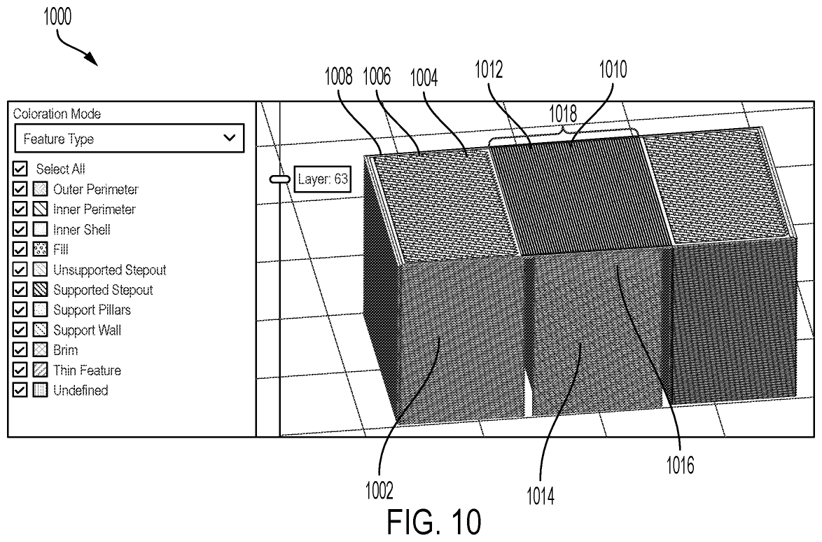

FIG. 10 depicts a schematic of a bridging layer formed onto support pillars to form a support for a 3D printed object having a central overhang, in accordance with the present disclosure. A more detailed view of the structure found in a part similar to that shown in FIG. 9. In previous printing systems and methods, a part or object 1000 would require supported step out portions 1012 directly on top of support pillars 1016 and unsupported step out portions 1010 between them. The three-dimensional printed part 1000 includes a central stepout or overhang 1018 portion of the part 1000, where a support wall 1014 and several support pillars 1016 are required to provide support to the overhang 1018. In this instance, the overhang 1018 is a central overhang. Also shown in the part 1000 are an inner perimeter 1006 of the top portion of inner perimeter 1006 of a stem 1002 which is a vertical portion of the part 1000, and a fill portion 1004 of the stem 1002. Also shown in this schematic are unsupported portions 1010 of overhang 1018.

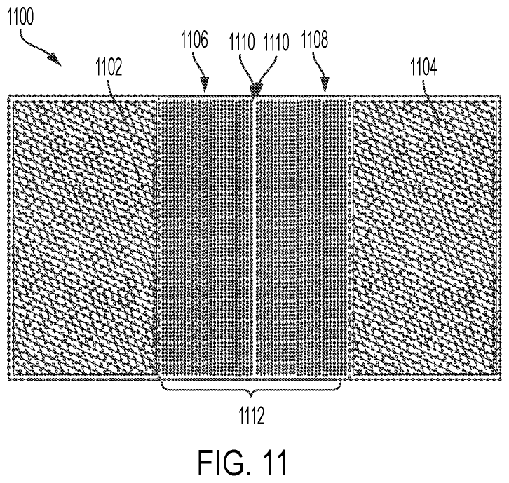

FIG. 11 depicts a top plan view of a drop-based version of the part having an unsupported stepout including a central overhang, in accordance with the present disclosure. As shown in a top view of the part 1100, within a central overhang 1112, there are drop-based print paths shown with a plurality of lines representing one or more paths and a plurality of circles representing the drops deposited along each path of printing material forming the layer of the part 1100. The lines and circles show a consistent line spacing and drop spacing for most of the portion of the central overhang 1112. A first stem portion 1102 forms a portion of the part 1100 built upon a planar substrate of a printing system and a second stem portion 1104 forms a portion of the part built upon a planar substrate of the printing system. A first central overhang portion 1106 is constructed from the first stem portion 1102, while a second central overhang portion 1108 is constructed from the second stem portion 1104. As the first central overhang portion 1106 and the second central overhang portion 1108 form the central overhang 1112, the drop spacing of the centermost print paths 1110 can be changed according to the calculations of the present disclosure.

Therefore, when printing an overhang of up to 3 mm without any supports for an extended overhang, or up to 6 mm for a central overhang, the unsupported overhang can be printed using a pulse or drop frequency of 100 Hz. Further, the drop spacing can be calculated for the last unsupported stepout or overhang portion for a 0 deg overhang according to the present teachings. Likewise, the drop spacing of a central overhang can be calculated. This calculation can be applied to a last support wall when printing a 0 deg overhang with supports. In examples, a metal drop ejecting apparatus having an ejector head configured to eject melted metal drops through a nozzle and a planar member, or substrate, positioned to receive melted metal drops ejected from the ejector head, and a controller operatively connected to the ejector head, the controller being configured to operate the ejector head to eject melted metal drops to form a continuous metal line over a first line of spatially separated pillars in a single pass of the ejector head over the first line of spatially separated pillars can be used in combination with one or more of the calculations or methods as described herein. Further, such a controller can be used to form a continuous metal line for an unsupported overhang in accordance with the present teachings.

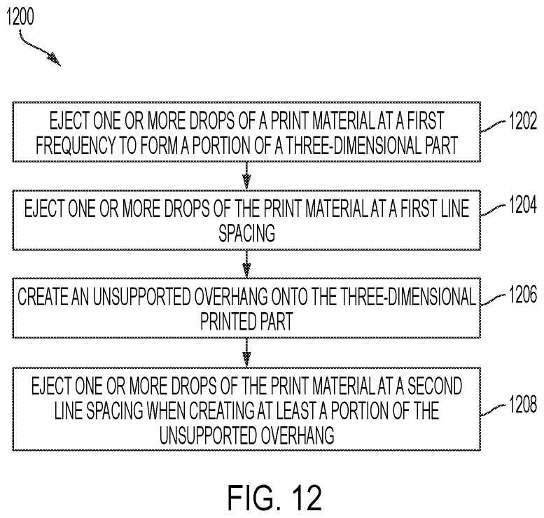

FIG. 12 is a flowchart illustrating a method for forming a three-dimensional part, in accordance with the present disclosure. The method of forming a three-dimensional part 1200 includes ejecting one or more drops of a print material at a first frequency to form a portion of a three-dimensional part 1202 and ejecting one or more drops of the print material at a first line spacing 1204. Next, the method of forming a three-dimensional part 1200 includes creating an unsupported overhang onto the three-dimensional printed part 1206, wherein the unsupported overhang is oriented at an angle of from 0 degrees to about 45 degrees relative to a print bed, followed by ejecting one or more drops of the print material at a second line spacing when creating at least a portion of the unsupported overhang 1208. The method of forming a three-dimensional part 1200 further includes wherein drops are ejected at a first drop spacing when ejected at the first line spacing or at the second line spacing, and no portion of the unsupported overhang contacts the print bed. In examples of the method of forming a three-dimensional part 1200, one or more drops of the print material can be ejected at a second frequency. In examples, the first frequency is from about 200 Hz to about 400 Hz, while the second frequency is from about 50 Hz to about 300 Hz, and in some examples, the second frequency is 100 Hz. In examples, for instance, if a smaller drop size is ejected, higher frequency ranges including but not limited to the kHz range or higher, may be employed in similar systems and in forming three-dimensional parts. In examples, the printing or formation of an unsupported overhang is conducted at lower frequencies as compared to other portions of the three-dimensional object. This is for the purpose of influencing the ejected print material drops in the overhang portion to solidify faster, or alternatively, to print such that ejected drops land when the previously ejected drops are sufficiently cold or solidified. The cooling that causes the droplet solidification is mostly influenced by the thermal conduction through the existing part, therefore the unsupported overhang has a challenging configuration because it has the least amount of contact with the existing structure or part. Lower frequency results in a longer time delay between drops, and thus can be helpful in such print build situations. This lower frequency of overhang printing is in comparison with printing frequencies associated with infill frequency, perimeter frequency, and supported overhang frequency. In such examples, the first frequency is higher than the second frequency, wherein, for example, the first frequency is 1.5, 2, 4, or 5 times greater than the second frequency.

In some examples of the method of forming a three-dimensional part 1200, ejecting one or more drops of the print material at a second frequency is done at the same time as ejecting one or more drops of the print material at a second line spacing. In certain examples, the unsupported overhang is an extended overhang, while in other examples, the unsupported overhang is a central overhang. The method of forming a three-dimensional part 1200 can include where either the first line spacing is greater than the second line spacing or alternatively, the second line spacing is greater than the first line spacing. Certain examples include where drops are ejected at a second drop spacing. In examples, the first drop spacing is greater than the second drop spacing, or alternatively, the second drop spacing is greater than the first drop spacing.

In example methods, one or more drops of the print material is ejected at a second line spacing when creating at least a portion of the unsupported overhang, or one or more drops of the print material is ejected at a second drop spacing when creating at least a portion of the unsupported overhang. The first line spacing is greater than the second line spacing, or the second line spacing is greater than the first line spacing. Where the unsupported overhang is an extended overhang, a lateral dimension of the unsupported overhang is up to 3 mm. Alternatively, where the unsupported overhang is a central overhang, a lateral dimension of the unsupported overhang is up to 6 mm. Methods of forming a three-dimensional part in accordance with the present teachings include ejecting one or more drops of a print material to form a portion of a three-dimensional part, ejecting one or more drops of the print material at a first line spacing while forming the three-dimensional part, creating an unsupported overhang onto the three-dimensional printed part, wherein the unsupported overhang is oriented at an angle of from 0 degrees to about 45 degrees relative to a print bed and no portion of the unsupported overhang contacts the print bed, and decreasing the first line spacing when creating at least a portion of the unsupported overhang. In examples, the print material includes a metal, a metallic alloy, or a combination thereof, such as but not limited to, aluminum.

In examples, the controller in the drop-on demand printer is configured to decrease line spacing as the overhang printing or building proceeds. While previously known techniques involve constant line spacing, the edges either curl up or drop off quickly. However, with methods of the present disclosure, a line spacing is used, that once printing an overhang will cause drop-off if continued at constant line spacing, but the controller will gradually transition to a line spacing that will cause curl up. It can be thought as a second-order approximation to a “flat” line. This method provides an extension of the “flat” region significantly compared to the first-order approximation based on constant line spacing. By reducing the line spacing as the overhang is printed, the part is less likely to exhibit fall off or droop towards the edge, and in certain examples, the object can be built such that the edge can be built up at an angle if the line spacing is too small. The second order approximation providing directions to the controller and printer can proceed in both directions. In examples, a second printing or pulse frequency can alternatively be implemented. Furthermore, drop spacing and line spacing can be adjusted independently or in concert to achieve flat overhang structures that are unsupported.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of forming a three-dimensional part, comprising:
ejecting one or more drops of a print material at a first frequency to form a portion of a three-dimensional part;
ejecting one or more drops of the print material at a first line spacing;
creating an unsupported overhang onto the three-dimensional printed part wherein the unsupported overhang is oriented at an angle of from 0 degrees to about 45 degrees relative to a print bed; and
ejecting one or more drops of the print material at a second line spacing when creating at least a portion of the unsupported overhang; and wherein:
drops are ejected at a first drop spacing when ejected at the first line spacing or at the second line spacing; and
no portion of the unsupported overhang contacts the print bed.

2. The method of forming a three-dimensional part of claim 1, further comprising ejecting one or more drops of the print material at a second frequency.

3. The method of forming a three-dimensional part of claim 2, wherein the first frequency is from about 1.5 to about 5 times the second frequency.

4. The method of forming a three-dimensional part of claim 2, wherein:
the first frequency is from about 200 Hz to about 400 Hz; and
the second frequency is from about 50 Hz to about 300 Hz.

5. The method of forming a three-dimensional part of claim 1, wherein ejecting one or more drops of the print material at a second frequency is done at the same time as ejecting one or more drops of the print material at a second line spacing.

6. The method of forming a three-dimensional part of claim 1, wherein the unsupported overhang is an extended overhang.

7. The method of forming a three-dimensional part of claim 1, wherein the unsupported overhang is a central overhang.

8. The method of forming a three-dimensional part of claim 1, wherein the first line spacing is greater than the second line spacing.

9. The method of forming a three-dimensional part of claim 1, wherein the second line spacing is greater than the first line spacing.

10. The method of forming a three-dimensional part of claim 1, wherein drops are ejected at a second drop spacing.

11. The method of forming a three-dimensional part of claim 10, wherein the first drop spacing is greater than the second drop spacing.

12. The method of forming a three-dimensional part of claim 10, wherein the second drop spacing is greater than the first drop spacing.

13. A method of forming a three-dimensional part, comprising:
ejecting one or more drops of a print material at a first frequency to form a portion of a three-dimensional part;
ejecting one or more drops of the print material at a first line spacing;
creating an unsupported overhang onto the three-dimensional printed part wherein the unsupported overhang is oriented at an angle of from 0 degrees to about 45 degrees relative to a print bed; and wherein:
drops are ejected at a first drop spacing when ejected at the first line spacing; and
no portion of the unsupported overhang contacts the print bed.

14. The method of forming a three-dimensional part of claim 10, further comprising:
ejecting one or more drops of the print material at a second line spacing when creating at least a portion of the unsupported overhang; and
ejecting one or more drops of the print material at a second drop spacing when creating at least a portion of the unsupported overhang.

15. The method of forming a three-dimensional part of claim 14, wherein the first line spacing is greater than the second line spacing.

16. The method of forming a three-dimensional part of claim 14, wherein the second line spacing is greater than the first line spacing.

17. The method of forming a three-dimensional part of claim 14, wherein:
the unsupported overhang is an extended overhang; and
a lateral dimension of the unsupported overhang is up to 3 mm.

18. The method of forming a three-dimensional part of claim 14, wherein:
the unsupported overhang is a central overhang; and
a lateral dimension of the unsupported overhang is up to 6 mm.

19. A method of forming a three-dimensional part,
ejecting one or more drops of a print material to form a portion of a three-dimensional part;
ejecting one or more drops of the print material at a first line spacing while forming the three-dimensional part;
creating an unsupported overhang onto the three-dimensional printed part, wherein the unsupported overhang is oriented at an angle of from 0 degrees to about 45 degrees relative to a print bed and no portion of the unsupported overhang contacts the print bed; and
decreasing the first line spacing when creating at least a portion of the unsupported overhang.

20. The method of forming a three-dimensional part of claim 19, wherein the print material comprises a metal, a metallic alloy, or a combination thereof.

21. A method of forming a three-dimensional part, comprising:
ejecting one or more drops of a print material at a first frequency to form a portion of a three-dimensional part;
creating an unsupported overhang onto the three-dimensional printed part wherein the unsupported overhang is oriented at an angle of from 0 degrees to about 45 degrees relative to a print bed; and
ejecting one or more drops of the print material at a second frequency when creating at least a portion of the unsupported overhang; and wherein:
the first frequency is higher than the second frequency.
